(19) United States
(12) Patent Application Publication
(10) Pub. No.: US 2007/0078674 A1
(43) Pub. Date: Apr. 5, 2007

(54) DISPLAY METHOD FOR IMAGE-BASED QUESTIONNAIRES

(76) Inventors: Irving N. Weinberg, Bethesda, MD (US); Edward Anashkin, Gaithersburg, MD (US); Deepa Narayanan, Germantown, MD (US); William Peter, Bethesda, MD (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/458,518

(22) Filed: Jul. 19, 2006

Related U.S. Application Data
(60) Provisional application No. 60/700,304, filed on Jul. 19, 2005.

(51) Int. Cl. G06Q 99/00; G05B 19/418

(52) U.S. Cl. 705/1; 705/8

(57) ABSTRACT

A network-enabled method and system for polling individuals about attributes of features that may be present on an image is provided. The system enables a user to indicate a region-of-interest, or to otherwise graphically indicate the location and extent of a feature, on an image. Information relating to the user's choice of location of the feature then appears in a dynamic questionnaire, thus permitting the user to efficiently describe the attributes of each feature, while recording the location and extent of the feature that the user is describing. The content of the user's responses to the questionnaire, and the record of location and extent of the features that the user has referenced, are transmitted to a server for recording and later analysis.

### BACKGROUND OF THE INVENTION

1. Field of the Invention

The present invention relates to a display method for image-based questionnaires, and more particularly to a web-enabled, interactive method of polling individuals about attributes of features that may be present on an image.

2. Description of the Related Art

Current web-enabled polling methods present users with questions that refer to an image. Typically, the entire image can be uploaded or otherwise referenced in its entirety by the user.

### SUMMARY OF THE INVENTION

In one aspect, the invention provides a system for enabling a user to answer questions related to one or more images. The system includes a display monitor configured to display the one or more images; a pointing device for selecting an image, a feature, or a region of interest (ROI) relating to an image; and a set of questions relating to the one or more images. The pointing device is selected from the group consisting of a mouse, a cursor button, an arrow button, and a pen. Responses by the user to one or more of the questions on the questionnaire can be modified based on selections made by the user relating to an image. The responses by the user to the questions and information relating to the selections are stored on a computer.

The system may further include a computer network. The display monitor may be configured to be connected to the network. The selections made by the user relating to one or more images may be interactive with the network. Each of the one or more images may provide a display relating to either a physiological function or an anatomic feature of a section of a human body. The section of the human body may be a breast, and the display may relate to a potentially cancerous lesion in the breast. The network may be the Internet, and wherein the responses by the user to the questions and information relating to the selections made by the user are configured to be communicated via the Internet.

At least one image may be derived by using positron emission tomography. At least one image may be derived from x-rays. A first image may be derived by using positron emission tomography and a second image may be derived from x-rays, and responses by the user to one or more of the questions can be modified based on a correlation between data relating to the first image and data relating to the second image.

In another aspect of the invention, a method for improving diagnostic accuracy with respect to either a physiological function or an anatomic feature of a predetermined section of a human body is provided. The method comprises the steps of: displaying one or more images relating to the predetermined body section; enabling a user to select one or more of an image, a feature, or a region of interest (ROI) relating to at least one image; providing a plurality of questions relating to the selected image or feature or region of interest; and storing response to the questions and information relating to the selection or selections on a computer. Responses to one or more of the questions can be modified based on the selection or selections.

The computer may be connected to a computer network. The step of displaying may be performed by using a display monitor that is configured to be connected to the network. The selection or selections relating to the at least one image may be interactive with the network. The network may comprise the Internet. The responses to the questions and the information relating to the selection or selections may be configured to be communicated via the Internet.

The predetermined body section may include a breast, and the step of displaying may include displaying a potentially cancerous lesion in the breast. At least one image may be derived by using positron emission tomography. At least one image may be derived from x-rays. At least a first displayed image may be derived by using positron emission tomography, and at least a second displayed image may be derived from x-rays, and responses to one or more of the questions may be modified based on a correlation between data relating to the first displayed image and data relating to the second displayed image.

### BRIEF DESCRIPTION OF THE DRAWINGS

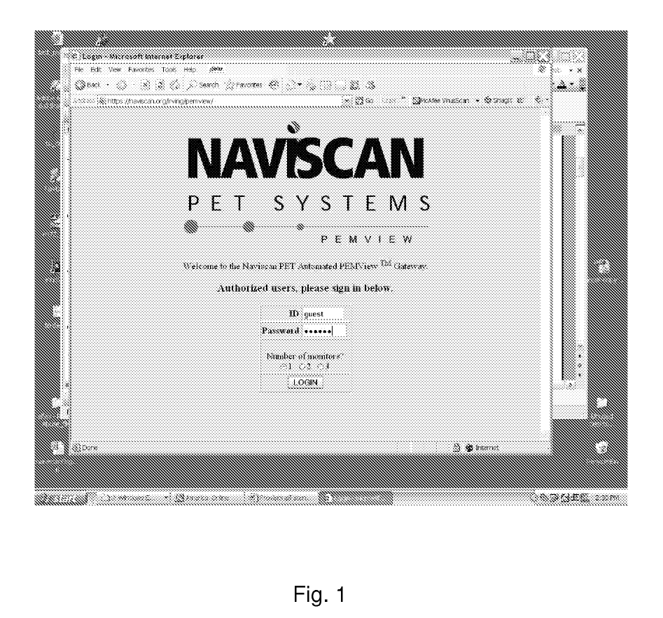

Each of FIGS. 1-15 shows a screen shot of a portion of an exemplary questionnaire and/or an image relating to the questionnaire, according to a preferred embodiment of the present invention.

### DETAILED DESCRIPTION OF THE INVENTION

The present invention provides an image viewing station for a positron emission tomography (PET) scanner device that is broadcast by the PET scanner server. The invention provides users with functionality as required to render an accurate diagnosis using PET images, and to collect patient data and to enable a radiologist to record his interpretation of the PET image.

The fundamental objective of the present invention is to enable viewing and interpretation of high-resolution PET images. In a preferred embodiment, a proprietary PET scanner device known as the PEM Flex PET Scanner device by Naviscan PET Systems, Inc. is used. The PEM Flex device is a high spatial resolution, small field-of-view device for developing a tomographic image of positron emissions within the human body. Referring to FIG. 1, the present invention, which, in a preferred embodiment, is implemented in a system known as PEMView by Naviscan PET Systems, Inc., is an image viewing platform for viewing, analyzing, and interpreting the PEM Flex images. In the case of breast images, it is believed that PEM Flex images may be correlated with low resolution x-ray images that provide an anatomic reference. Accordingly, the goals of the present invention include the following:
1) Ability to collect, store, and display information about a patient's relevant medical history;
2) Ability to display the PET images without loss in data quality;
3) Display of the correlative digitized mammograms;
4) Ability to perform image analysis functions on the PET and x-ray images;
5) Ability to record the radiologist's interpretation of the PET images and to print a PET image report;
6) Ability to enable a referring physician to view the PET images in conjunction with the radiologist's report;
7) Ability to transfer data to and from the host server;
8) Ability to transfer PET images and data in DICOM format to and from the site system;
9) Ability to create case report forms and specific image review forms from the preexisting templates; and
10) Ability to set up a questionnaire form for clinical trials, including data analysis software.

The current invention permits the user to draw a region-of-interest around, or to otherwise graphically indicate the location and extent of a feature, on an image being displayed on a monitor, such as a computer screen. Information as to the user's choice of location of the feature (or features) then appears in the questionnaire, permitting the user to efficiently describe the attributes of each feature, while recording the location and extent of the feature that the user is describing. The content of the user's responses to the questionnaire, and the record of location and extent of the features that the user has referenced, are transmitted to a server for recording and later analysis.

Digital files containing images are uploaded from a computerized medical device to a server. The server can then send the image, together with other dynamic content, to a client computer. The upload and transmission processes could be done using a suitable scripting language on the server (e.g., PHP, Python, etc.). The dynamic content may include a questionnaire. If the questionnaire uses image-based data (e.g., JPG files) as part of its content, the image-based data will be sent to the client. Conditional questions based on the image, i.e., questions that are dependent on the presence or absence of certain features in the image, are supported, for example, through a scripting language, such as Javascript. The client also downloads software (e.g., Java applet, Macromedia Flash applet, etc.) from the server. Using the software, the user can draw a region of interest (ROI) on the image using a pointing device such as a pen or a mouse, which outlines the feature of interest. Typical users include radiologists, nuclear medicine physicians, surgeons, support technicians and technologists, medical physicists, biotechnical personnel, clinical data analysts, and clinical trial coordinators.

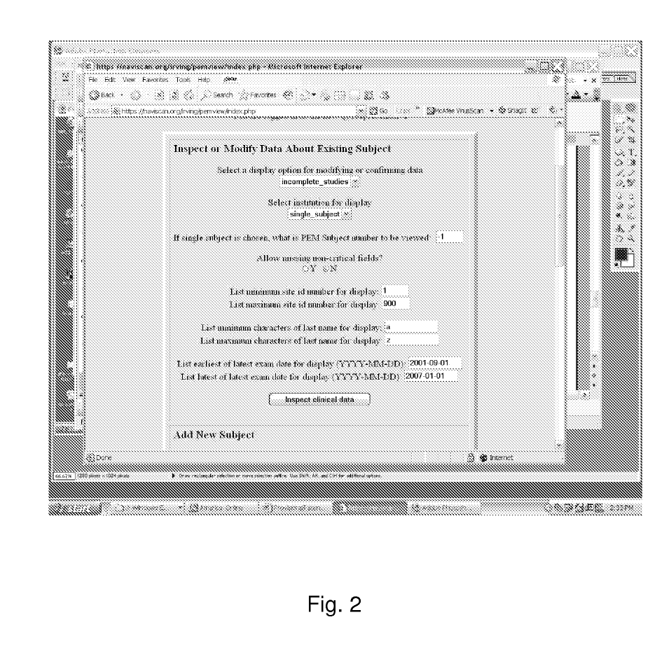

An exemplary questionnaire according to a preferred embodiment of the invention, including examples of pages available to the user, is shown in the attached figures. FIG. 1 is the first figure demonstrating operation of the system. Referring to FIG. 1, a user must log into the software utility by providing a username and password. Referring to FIG. 2, an illustration that a user can sort through a database of patients in order to select one or more patients to examine is provided.

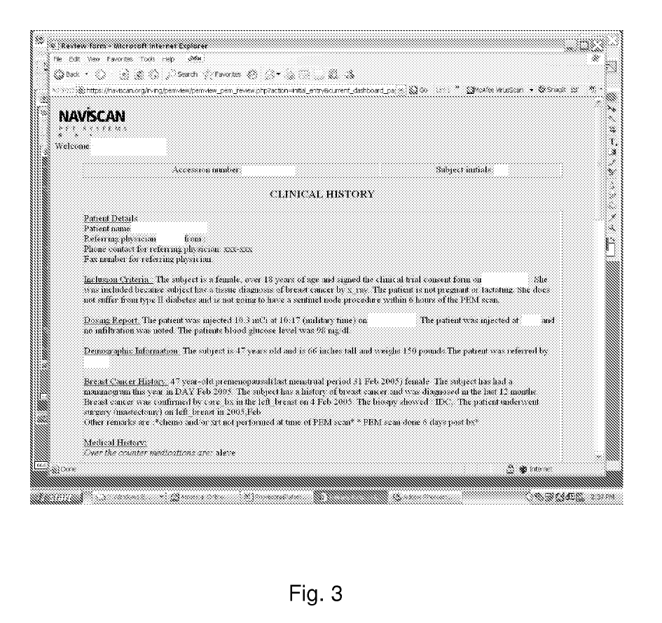

Referring to FIG. 3, a patient record has been selected. This record includes a questionnaire that is intended to be filled out by a reviewer of the images. The questionnaire provides some clinical information about the patient, in order to assist in interpreting the images. The clinical information is derived from the database, which contains data entered electronically by a patient, a caregiver, or a clinical trial nurse. Identifiable information has been removed from the figure, for privacy reasons.

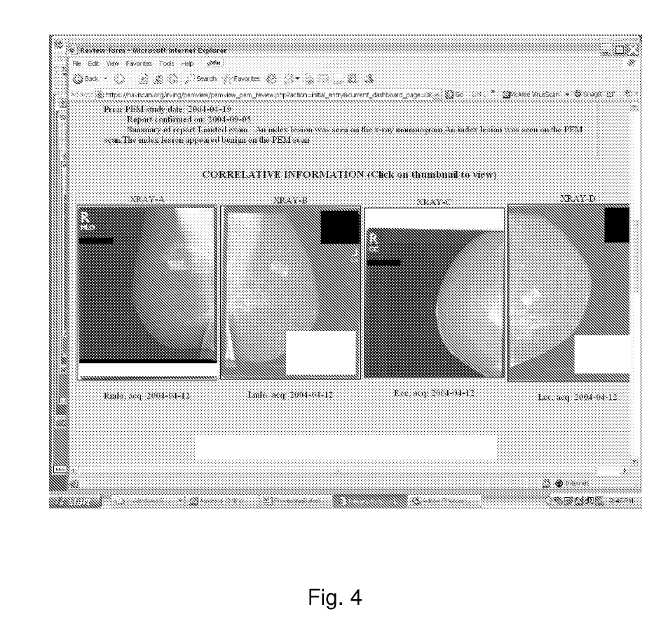

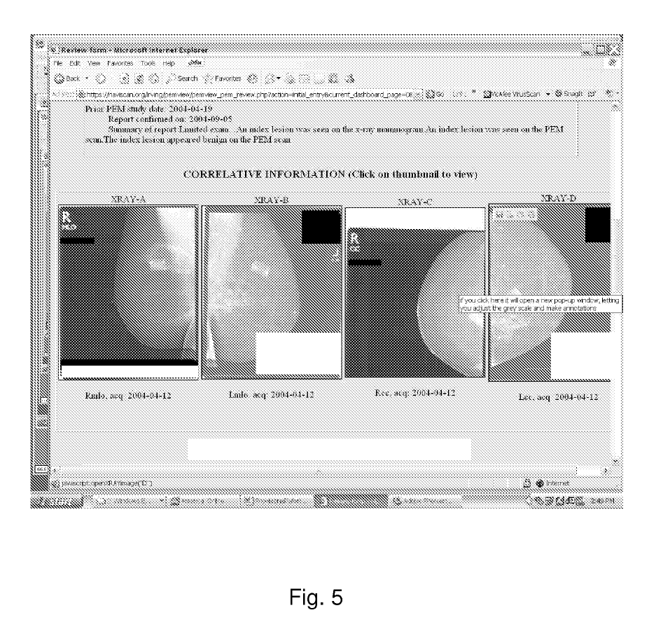

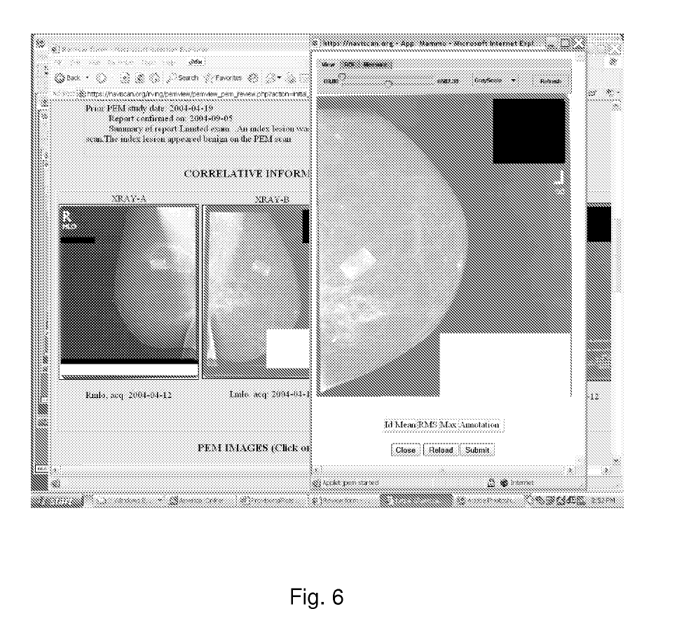

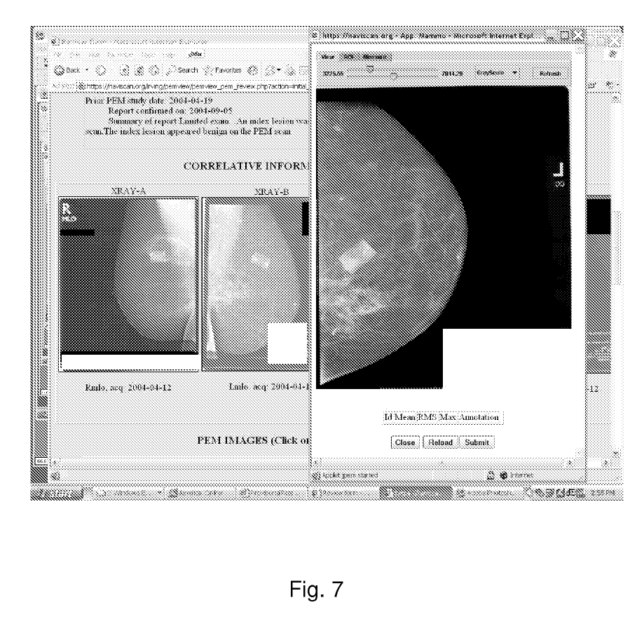

Referring to FIG. 4, a different section of the same questionnaire is shown. This section shows thumbnail views of anatomic images in Joint Photographic Experts Group (JPEG) format, in particular, x-ray mammograms. Once again, identifiable information has been removed from the figure, for privacy reasons. Referring to FIG. 5, the user has moved a cursor across the rightmost of the four thumbnail images. When the user selects this image, for example, by clicking on the mouse, with the mouse at this location, a page will be downloaded that will include an enlarged (i.e., blow-up) view of the thumbnail image that can be operated upon using, for example, a Java applet. Referring to FIG. 6, the enlarged view is illustrated. This enlarged view may be operated upon with the software (e.g., a Java applet). Referring to FIG. 7, one Java applet operation is illustrated. In this operation, the gray scale of the image has been modified to make the image look darker.

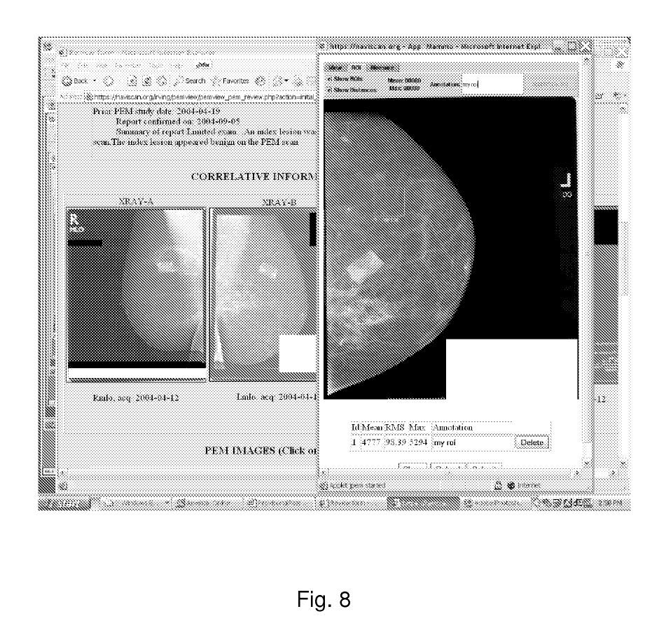

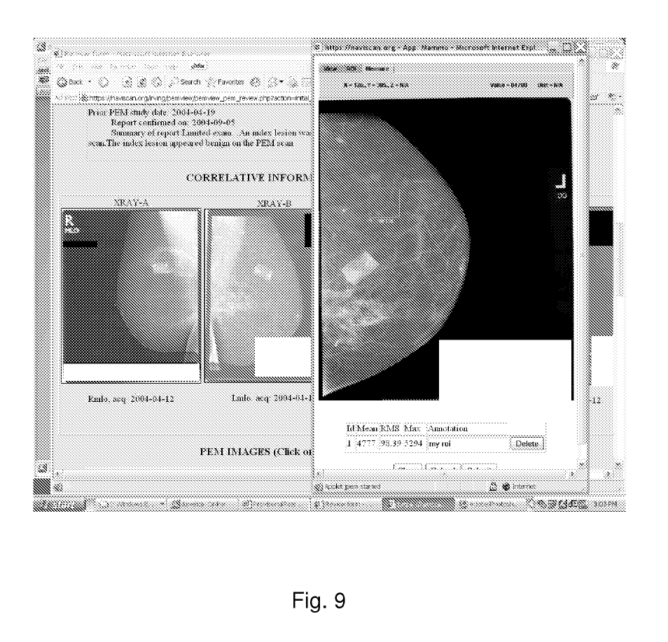

Referring to FIG. 8, another Java applet operation is illustrated. In this operation, a square region of interest (“ROI”) has been drawn, and named. The ROI is indicated by the white box with the words “My ROI” underneath it, in the left-central portion of the enlarged image. The coordinates of the ROI, its name, and properties of the area defined by the ROI are stored in a list whose information can be transferred to the main questionnaire page or to a database. Referring to FIG. 9, another Applet operation is illustrated, in which the cursor is used to demonstrate a distance, by clicking on the tab labeled “Measure”.

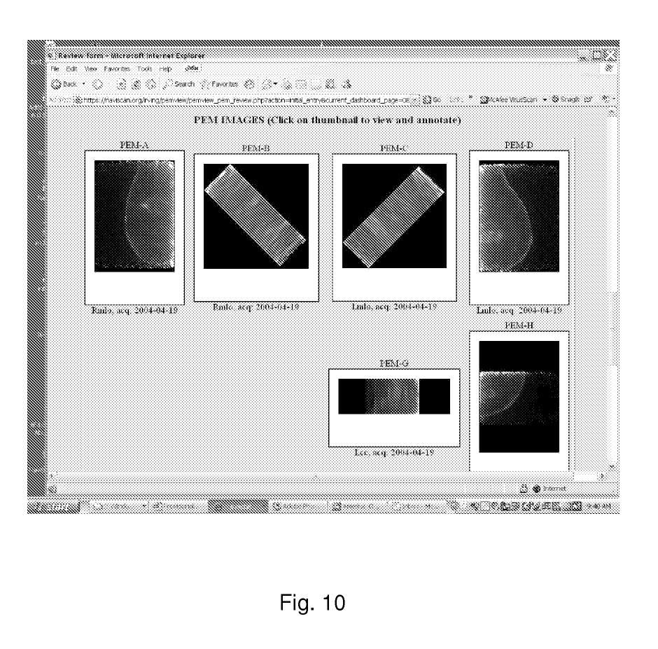

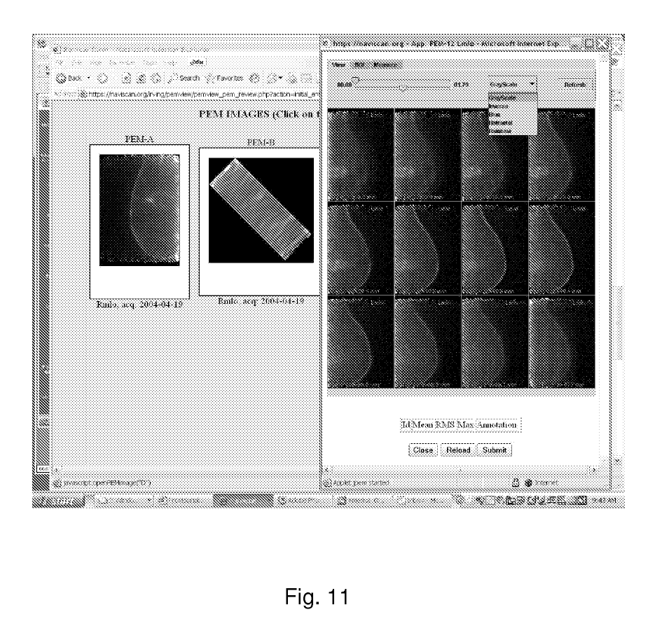

Referring to FIG. 10, images that include thumbnail views of functional imaging studies on the same subject are shown. These thumbnail views include high resolution positron emission tomographic (“PET”) views of a breast. Because the PET studies represent three-dimensional structures, the thumbnail views are actually maximum-intensity projections (“MIP”) of the structures. Referring to FIG. 11, when a user selects one of the thumbnail views (in this example, the user has clicked on the view labeled “PEM-D” in FIG. 10), a three-dimensional representation of the functional imaging study is shown as a set of slices through the imaging study. Similarly as with the correlative anatomic images shown in FIGS. 4-9, ROI and distance measurements can be obtained on the functional images.

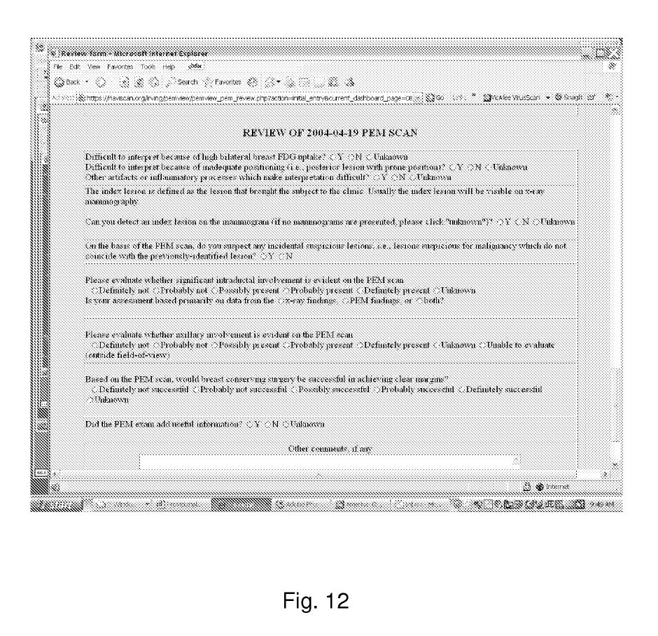

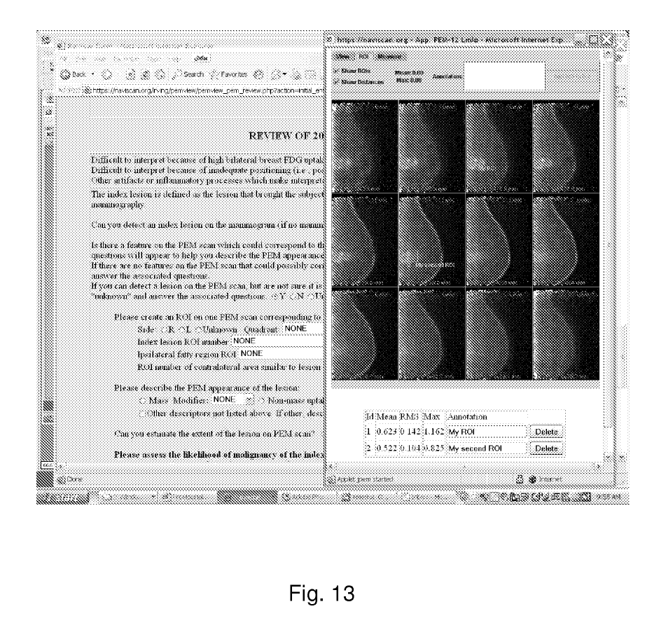

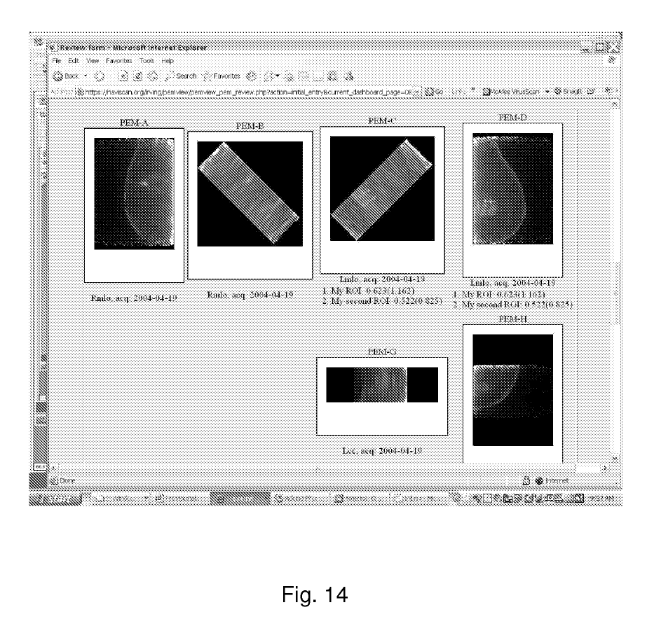

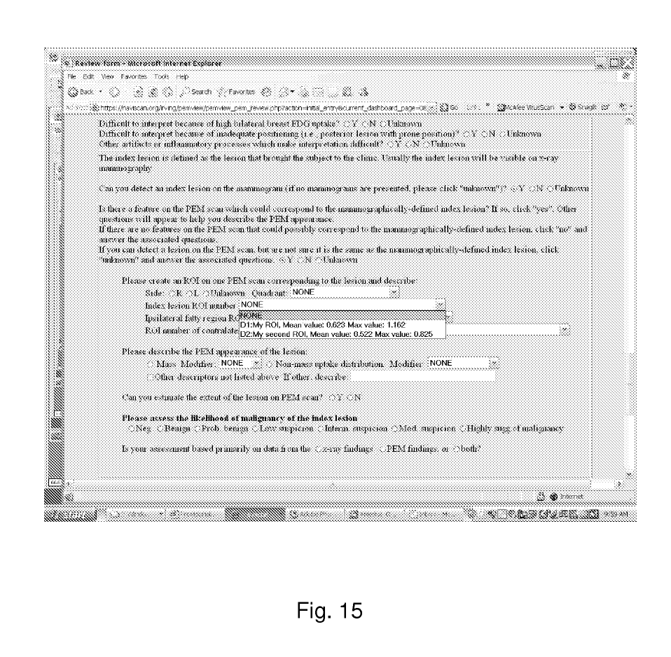

Referring to FIG. 12, the lower part of the exemplary questionnaire is shown. This section of the questionnaire queries a reader about his or her impressions of the case. Referring to FIGS. 13-15, several key and innovative elements of the present invention are illustrated. In FIG. 13, the user has drawn two ROIs in the PET image set, respectively labeled “My ROI” and “My Second ROI”. Referring also to FIG. 11, the user has also submitted the information to the database by clicking on the button labeled “Submit”. The outlines of the two ROIs are visible on the three-dimensional representation of the PET image set in FIG. 13, and in the two thumbnail views labeled “PEM-C” and “PEM-D” shown in FIG. 14. As illustrated in FIG. 15, questions can appear in the questionnaire conditionally, as a result of responses by the user to different questions, which may be coded using Javascript, PHP, or any other scripting language.

Importantly, the questionnaire on FIG. 15 shows a drop-down list of ROIs that have been declared by the user, and allows the user to select from this drop-down list and enter descriptions about each ROI. This feature is critical, as it allows a user to declare the location of a feature graphically (e.g., by using a mouse to draw an ROI), and then to describe the feature in a questionnaire. Because imaging studies are important for clinical trials and also for clinical practice, the ability to describe a case on a feature-by-feature basis is especially valuable. In particular, this feature is distinct from conventional clinical trial software that is limited to describing the image as a whole. Using conventional methods, a reader would likely see images of two breasts, noting that in the upper outer quadrant of the right breast, there is a suspicious cluster of microcalcifications, and in the lower inner quadrant, there is a benign-appearing lesion, most likely a fibroadenoma. By contrast, the present invention enables the reader to draw an ROI around each lesion, describe each lesion using predefined qualifiers or new qualifiers (i.e., in the box labeled “If other, describe:”), and have the data about each lesion stored separately in a database.

Because the functional images are three-dimensional, and also contain biochemical and/or physiological information, the power of having a system that can describe individual lesions is great, since it allows lesions of a certain type to be compared from patient to patient. The present invention also allows the data collected from readers to be displayed to referring physicians, because information from the database can be extracted and shown to users entering with distinct log-in information. Thus, a physician can view information, including the actual images commented on by the readers, along with the comments about each lesion made by one or more readers, on all his patients. Accordingly, the present invention provides the physician with a powerful clinical tool.

Preferably, the system of the present invention is capable of displaying all of the PET scanner image views at a full 1:1 scale. The system is capable of displaying digitized x-ray images that correspond to the PET scanner images. In addition, the system is capable of displaying physiologically meaningful values relating to radiotracer concentration at each location visible in an image, with calculated attenuation correction and standardized uptake value. The system is capable of displaying regions of interest as designated by the interpreting physician, and of enabling quantitative analysis of such regions of interest. The system includes the capability of collecting and displaying a patient's relevant medical history, and the capability of recording PET scanner image interpretation by all radiologists and other analysts, including annotations and regions of interest, and to print patient reports. The system also has the capability of transmitting device and patient data in a secure fashion, e.g., in compliance with HIPAA and 21 C.F.R., Part 11. The viewer station is typically web-based or Internet-based, thus enabling users to log in and view images from remote locations. In addition, the system has on-board utilities for data archival, such as, for example, HDD or DVD or CD storage media.

In a preferred embodiment, the software used by the system of the present invention will ensure data security and patient confidentiality. The system is Ethernet and/or network compatible. The image displays have DICOM/PACS compatibility, and can be outputted to a video monitor or to a network printer or a local printer. In some implementations, a multimode image display option may be provided.

In a preferred embodiment, a network printer is specified for use with the image workstation functions, using the Lorad™ Multicare™ with DSM upgrade. A digitized is optionally specified for use to provide the ability to digitize a patient's x-ray mammograms such that they can be uploaded to the system. A workstation capable of viewing the images is also specified. The workstation cart includes at least one, and preferably two, monitors capable viewing the high-resolution mammography images. Typically, the system will reside primarily in a mammography suite, for use by breast health caregivers.

In a preferred embodiment, the system of the present invention includes an electronic client device that is connected to a host server via a network. A typical user, such as a physician or a laboratory technician, uses the client device to access the system, which is hosted on the host server. The system is implemented electronically by software that is installed on the host server.

The host server is preferably implemented by the use of one or more general purpose computers, such as, for example, a Sun Microsystems F15k. The client device is also preferably implemented by the use of one or more general purpose computers, such as, for example, a typical personal computer manufactured by Dell, Gateway, or Hewlett-Packard. Each of the host server and the client device can include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The host server may use its microprocessor to read a computer-readable medium containing software that includes instructions for carrying out one or more of the functions of the host server, as further described below.

Each of the host server and the client device can also include computer memory, such as, for example, random-access memory (RAM). However, the computer memory of each of the host server and the client device can be any type of computer memory or any other type of electronic storage medium that is located either internally or externally to the host server or the client device, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), or the like. According to exemplary embodiments, the respective RAM can contain, for example, the operating program for either the host server or the client device. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the host server and the client device can also include a database. The database can be any type of computer database for storing, maintaining, and allowing access to electronic information stored therein. The host server preferably resides on a network, such as a local area network (LAN), a wide area network (WAN), or the Internet. The client device preferably is connected to the network on which the host server resides, thus enabling electronic communications between the host server and the client device over a communications connection, whether locally or remotely, such as, for example, an Ethernet connection, an RS-232 connection, or the like.

The client device typically includes a monitor for displaying the images and the questions relating to a clinical diagnosis. The client device may be configured to accept user inputs provided via one or more of a keyboard, a mouse, and a joystick.

Although an implementation of the system uses computers, or other similar network devices, that are “on line”, i.e., connected to a network such as a local area network (LAN) or the Internet, it is possible to implement the system so that a computer need not be on line while the data is being commented upon by the reader. In such a configuration, a network server can load one or more files encoding the question and image data onto the computer while the computer is acting as a client. The client computer may be a personal desktop assistant (“PDA”) or tablet computer. The user can then take the client computer off line, and software on the computer, such as a program written in Java or another language, can redisplay the questionnaire and image data on the monitor off line, i.e., unconnected to a computer network. The reader can enter his or her responses to the image-based questionnaire, and have the information stored in one or more files on the local computer. It is noted that the questionnaire is presented to the user in a dynamic fashion. This means that the questions and other details presented to the user may change according to the user responses. For example, different questions may be presented to persons who have had particular medical histories. Image-based questions would also be dynamically presented so that particular questions could be directed to regions of interest that exhibit clinical peculiarities.

When the user hits an appropriate button on the computer software, the computer will attempt to upload the form response back to the network server. The form response comprises one or more files, and includes responses to the questions, including image-based questions, such as the coordinates of the ROI or any other relevant image-based response. If the computer is not on a network, or if an upload connection is not made immediately, the software will continue attempting to make a successful upload to the server. When this form is finally uploaded to the server, image-based information, such as the ROIs and the user's responses to questions about each ROI, are sent to a database on the server for storage.

In a preferred embodiment, the system of the present invention can be understood as having a client structure, a server structure, and a network connectivity structure. The client structure includes the graphical user interface (GUI), the image display, and the image processing tools for use by a radiologist or any on-site user. The images may be read using a web browser or a dedicated software package that can be installed by any user. The server structure includes an SQL database, an Apache server, and storage and data processing functionalities. The network connectivity structure includes connectivity between the PET scanner and the system, PACS connectivity, and connections to RIS/HIS and a DICOM interface module for transfer of images.

System software users will typically include site users, such as clinical users. More particularly, users may include administrative users; technologists; site radiologists; referring physicians; teachers/guest users; front desk/accounts users; or clinical trial radiologists. The system software may be classified into different modules, including: 1) security module; 2) clinical history module; 3) image display module; 4) image processing and analysis module; 5) data transfer module; 6) archive/backup module; 7) clinical trial module; 8) user customization module; and 9) help utility module.

The security module provides software security features for restricting data access to different users according to the user type. The login has a timeout feature. If there has been no activity on the system within a predetermined period of time, the user is not able to access the system. If there has been no browser activity for a predetermined period of time, the user is automatically logged off. Administrator users can use the security module to perform several functions, including: 1) assigning new user identifications and temporary passwords (which would typically be changed on first login by the new user); defining user types for each user (i.e., administrative, radiologist, or technologist); deleting users from the system; and entering and modifying site information. System software maintains a record of all procedures performed on the system by each user that could potentially affect patient data performance or patient security.

The clinical history module registers the patient and collects information about the patient's previous medical history. In addition, this module enters information relating to indication, staging reports, and treatment records. For clinical patients, there is an option to reduce data entry by the technologist. Physicians may have an option to obtain a history through charts or the hospital's information management system. If the patient is part of the clinical protocol, the module will include a signed informed consent that allows information to be collected and transferred electronically to data collection headquarters for use by authorized users. The Case Report Forms have information relating to patient demographics, current and previous breast cancer history, previous medical history and medications, reproductive history, risk factors, all diagnostic and staging reports, and records of previous treatment regimes. The clinical history module may be able to automatically obtain a modality work list form the site RIS/HIS or the site PACS, and to access and record imaging reports and pathology reports from the hospital information system.

The clinical history module is typically used primarily by site technologists, by front desk personnel, and by the site administrator. The front desk personnel can check that the patient has been registered for a PET scan procedure, determine which type of PET scan procedure is being performed, and whether the procedure has been completed. A technologist can perform several functions with this module, including: 1) registering a new patient or verifying that automatic registration has been correctly completed; 2) entering relevant patient information as required; 3) searching and retrieving data for a patient according to his current study status or date of last PET scan or last name or medical record number; 4) printing out the site radiologist's PET scan interpretation report; and 5) modifying or correcting incorrect information about a patient. A typical list of current study statuses may include: 1) available cases (i.e., complete patient information is available); 2) unread cases (i.e., cases not yet reviewed by the site radiologist); 3) unconfirmed cases (i.e., cases that do not have a completed PET scan report); and 4) confirmed cases (i.e., cases saved with confirmation by the radiologist).

The system provides templates for creation of specific Case Report Forms that have an extensive list of questions from which a customized, patient-specific or trial-specific questionnaire may be created. Typical information to be included in a Case Report Form may include: 1) registration information, including patient name, medical record number, birthdate, and indication for PET scan; 2) patient inclusion criteria; 3) patient demographics; 4) patient dosing information; 5) patient breast cancer history; 6) patient medical history; 7) patient reproductive history; 8) risk factors; 9) imaging history; and 10) pathology and staging.

The image display and review module displays the PET scan images and the correlative full resolution x-ray mammograms. Both the PET scan and x-ray images for a selected patient may be displayed as thumbnail images in a film-strip orientation. Each thumbnail has a date of the PET scan imaging associated with it. A user can drag and drop the PET scan images into the central viewing area. The image viewing area may be divided into four quadrants, each capable of displaying one PET scan or x-ray view. The user can customize hanging protocols such that each time a patient is selected, the images are hung in the same orientation. For example, monitor 1 may be configured to display two PET scan CC views and two x-ray CC views, and monitor 2 may be configured to display two PET scan MLO views and two x-ray MLO views. The user can then display PET scan images in either a three-dimensional MIP format to allow the user to “swim” through slices, or a 12-slice format that allows the display of all slices simultaneously. The user can toggle between these two image viewing modes. The user can also click on one particular slice to get a zoomed image of that slice, and then go back and forth to other slices in the data set. Each PET scan image is annotated by the side and the view of the image. The lateral, medial, superior, and inferior sides of the breast are indicated on each PET scan image. Annotations also include the date of the imaging, the slice thickness, and the breast compression.

The image display and review module is capable of importing x-ray images from either the PACS system or the Apache server at the site and then displaying them using a standard hanging protocol. When the thumbnail images are dragged and dropped into the main viewing area, low resolution images (i.e., approximately 300 dpi) of the patient's mammogram are displayed. If a user targets a particular region of interest for closer inspection, high resolution images of that ROI may be available. There may also be an option to view the complete full resolution x-ray image. The module also provides a brief description of the patient's clinical indication and the recorded clinical history and/or interpretations of previous PET scans.

The image display and review module assists the radiologist in creating a PET scan image report by presenting the reviewer with a series of questions relating to describing the appearance of the lesions shown in the PET scan. Responses to the questions are assembled in the form of an imaging report. Users may store selected regions of interest and associated annotations for later retrieval for confirmation or review purposes. The site radiologist is able to view PET scan images and correlative diagnostic x-ray images in a similar configuration, including all PET scan images performed for that patient at that site. The radiologist may record interpretations of PET scan images. The radiologist may obtain a report relating to previous PET scans for that patient.

The referring physician is able to view PET scan images relating to his referred patients. The referring physician may view x-ray images and the site radiologist's report, and may view the regions of interest drawn by the site radiologist. A guest user may be given access to data relating to teaching cases or training cases for which patient identification data has been removed. This data may be encrypted. Limited access to patient clinical history and pathology may be provided. The guest user may be able to view the clinical indication and then record his own interpretation of a PET scan image. A site technologist may view the clinical indication for PET scan imaging, both PET scan and x-ray images, and any radiologist's interpretive reports. The site technologist can select and display patient images, arrange them in the current hanging protocol, and verify that the correct images are present in the correct orientation. However, the site technologist may not make any interpretations or modify or change any interpretations previously made by the site radiologist. The clinical trial radiologist is able to view the patient's detailed clinical history and both PET scan and x-ray images. However, the clinical trial radiologist does not have access to previous imaging reports or pathology data. The clinical trial radiologist may complete the image review questionnaire, and may also modify or add to the questionnaire itself, depending on the type of clinical trial.

The image processing and analysis module provides a user with the ability to correlate x-ray images with PET scan images, and to perform image processing operations on the PET scan images in order to derive quantitative information. Available image processing tools may include:
1) Window leveling—enables a user to adjust the contrast and brightness of both PET scan and x-ray images;
2) Slice—enables a user to proceed through the different slices of a three-dimensional PET scan image;
3) Zoom—enables a user to zoom the PET scan image to display a magnified image of a single slice, or to zoom into a section of an x-ray mammogram;
4) Image Manipulations—e.g., flipping or rotating a PET scan or x-ray image by a user-controlled number of degrees of rotation;
5) Color Scales—enables a user to display images in different color scales, including inverse, with different maximum/minimum values;
6) SUV Maps—enables a user to set his own maximum and minimum SUV values and to adjust color maps accordingly, for example, if a user states the SUV range as 0.5-3.0, then all values below 0.5 would be one color, all values above 3.0 would be a second color, and all values between 0.5 and 3.0 would display a color gradation;
7) Image Coordinates and Measurement—enables a user to interrogate image coordinates, e.g., to know the SUV value at a selected image coordinate, and to measure lengths;
8) ROI—enables a user to draw a region of interest on a displayed image, to annotate that ROI, and to save relevant information that can be exported to other software applications for quantitative analysis or for use in acceptance tests;
9) Filters—enables a user to use several filters, such as a Gaussian filter or a smoothing filter, to modify the PET scan images;
10) 3-D Image Visualization—enables the user to reconstruct the three-dimensional tomographic PET data to view that data;
11) Save As—enables the user to save the PET scan image or the x-ray image as a DICOM, bitmap, or tif file; and
12) CAD—a computer aided diagnosis component that presents the most suspicious areas in the PET scan image to the user for analysis.

The data transfer module allows a user to transfer patient data and images inside to the hospital and to outside authorized users. Data may be encrypted, and patient identifiers may be removed, depending on the particulars of a given transfer. PET scan images are sent to the Apache server for later access via the image display module. PET scan images are also transferred to the site PACS system in DICOM format. X-ray images are digitized and then transferred to the Apache server for later access via the image display module. The x-ray images may be obtained by downloading the high resolution images from the site PACS system. Other diagnostic images, such as whole body PET scan images, MRI images, and ultrasound images, may also be transferred from the site PACS to the server. Diagnostic images may be transferred to a third party as part of a clinical trial; generally, when transferring such data offsite, patient identification data is deleted, and image data may be encrypted for security.

The backup, storage, and archive module allows a user to save images and data to the server, to delete data files from the system, and to restore data files from media. The backup, storage, and archive module enables a user to: 1) delete a patient or a particular PET scan study for a patient; 2) repopulate the system database from an xml file obtained from a PET scan device; 3) enter a new patient identification, or register a new patient; 4) restore and read patient images in DICOM format from a media disk or from the hard drive; 5) periodically perform automatic backups to existing data in the system; and 6) perform basic query retrieval operations to gather certain types of information, such as, for example, the number of patients scanned in the last week or the total number of patients referred by a particular physician. The backup, storage, and archive module is primarily accessed by the site technologist and the site administrator.

The clinical trial module is used by the clinical trial team to collect information about patients, display PET scan images, and obtain specific interpretations of PET scan images either alone or in conjunction with other types of images. A Case Report Form (CRF) may be created using a template of questions used in the clinical history module. A user can modify the template to create a customized questionnaire for a given patient. The Patient Review Form (PRF) is typically used by a radiologist to enter an interpretation of a PET scan image. For some questions, multiple images must be viewed; in these instances, the questionnaire may include a software check and an ability to lock an entry once submitted. For cases in which two or more radiologists are to provide multiple readings of the same case, the system may ensure that readings by a previous radiologist are not displayed. A patient image display is used to ensure that images are displayed in a particular order or according to a specified hanging protocol with preset image processing tools, according to the clinical protocol. The data entered in the CRFs and PRFs, including ROI information, is saved in an SQL database. The clinical trial module also provides statistical and mathematical tools for performing data analysis.

The customization module allows a user to configure the system reading station and software to his individual preferences, i.e., number of monitors, display parameters, and patient data to be displayed in conjunction with images. The customization module provides for site customization and user customization modes. The site customization modes provides several functions, including: 1) ability to configure the reading station, including the number of monitors; 2) ability to select a background page color; 3) ability to select predefined questions or information to be displayed on the patient history or review form questionnaire page; 4) ability to select time for automatic backup; 5) ability to select and save time zone and measurement units for distance, height weight, and dose activity; and 6) ability to customize the look and feel of dictated PET scan imaging reports. The user customization module provides several functions, including: 1) ability to select the types of images being displayed (e.g., 3-D images, MIP images, or YMIP images); 2) ability to select and save predefined color scales; 3) ability to set and save predefined SUV color map scales; 4) ability to select type of SUV data, ROI annotation, and display style; 5) ability to select and customize a hanging protocol; 6) ability to select display of images in ascending or descending chronological order, or by patient name or patient identification number; and 7) ability to select mouse and keyboard shortcuts for frequently used image processing tools.

The help and troubleshooting module provides help to a user in the form of a user manual. A user may launch the help module at any time. The user can use search tools to search for additional information on any topic. The manual has clear step-by-step instructions to perform any required operation. The user is provided with contact numbers for customer service. The software administrators can access the system to troubleshoot problems.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A system for enabling a user to answer questions related to one or more images, comprising:
a display monitor configured to display the one or more images;
a pointing device for selecting an image, a feature, or a region of interest (ROI) relating to an image; and
an interface for providing a plurality of questions relating to the one or more images,
wherein the pointing device is selected from the group consisting of a mouse, a cursor button, an arrow button, and a pen; and
wherein responses by the user to one or more of the questions can be modified based on selections made by the user relating to an image, and wherein the responses by the user to the questions and information relating to the selections are stored on a computer.

2. The system of claim 1, the system further comprising a computer network, wherein the display monitor is configured to be connected to the network, and wherein the selections made by the user relating to one or more images are interactive with the network.

3. The system of claim 2, wherein each of the one or more images provides a display relating to either a physiological function or an anatomic feature of a section of a human body.

4. The system of claim 3, wherein the section of a human body comprises a breast.

5. The system of claim 4, wherein the display relates to a potentially cancerous lesion in the breast.

6. The system of claim 2, wherein the network comprises the Internet, and wherein the responses by the user to the questions and information relating to the selections made by the user are configured to be communicated via the Internet.

7. The system of claim 1, wherein at least one image is derived by using positron emission tomography.

8. The system of claim 1, wherein at least one image is derived from x-rays.

9. The system of claim 1, wherein at least a first image is derived by using positron emission tomography, and at least a second image is derived from x-rays, and wherein responses by the user to one or more of the questions can be modified based on a correlation between data relating to the first image and data relating to the second image.

10. A method for improving diagnostic accuracy with respect to either a physiological function or an anatomic feature of a predetermined section of a human body, the method comprising the steps of:
displaying one or more images relating to the predetermined body section;
enabling a user to select one or more of an image, a feature, or a region of interest (ROI) relating to at least one image;
providing a plurality of questions relating to the selected image or feature or region of interest; and
storing response to the questions and information relating to the selection or selections on a computer,
wherein responses to one or more of the questions can be modified based on the selection or selections.

11. The method of claim 10, wherein the computer is connected to a computer network, and wherein the step of displaying is performed by using a display monitor that is configured to be connected to the network, and wherein the selection or selections relating to the at least one image are interactive with the network.

12. The method of claim 11, wherein the network comprises the Internet, and wherein the responses to the questions and the information relating to the selection or selections are configured to be communicated via the Internet.

13. The method of claim 10, wherein the predetermined body section comprises a breast.

14. The method of claim 13, wherein the step of displaying comprises displaying a potentially cancerous lesion in the breast.

15. The method of claim 10, wherein at least one image is derived by using positron emission tomography.

16. The method of claim 10, wherein at least one image is derived from x-rays.

17. The method of claim 10, wherein at least a first displayed image is derived by using positron emission tomography, and at least a second displayed image is derived from x-rays, and wherein responses to one or more of the questions can be modified based on a correlation between data relating to the first displayed image and data relating to the second displayed image.
